(19) United States
(12) Patent Application Publication
(10) Pub. No.: US 2025/0087416 A1
(43) Pub. Date: Mar. 13, 2025

(54) Multi-Winding Transformer and Power Conversion Device

(71) Applicant: Hitachi, Ltd., Tokyo (JP)

(72) Inventors: Abhijit CHOUDHURY, Tokyo (JP); Takae SHIMADA, Tokyo (JP)

(21) Appl. No.: 18/814,745

(22) Filed: Aug. 26, 2024

(30) Foreign Application Priority Data
Sep. 13, 2023 (JP) 2023-148420

(51) Int. Cl. H01F 30/12; H02M 1/00; H02M 5/14

(52) U.S. Cl. CPC H01F 30/12; H02M 1/0074; H02M 5/14

(57) ABSTRACT

A multi-winding transformer for insulation has a magnetic core having a plurality of legs, and a primary winding and a secondary winding wound around each of the plurality of legs. Voltages having different phases are input from power converters to the primary windings wound around two different ones of the plurality of legs.

### CLAIM OF PRIORITY

The present application claims priority from Japanese application serial no. 2023-148420, filed on Sep. 13, 2023, the content of which is hereby incorporated by reference into this application.

### BACKGROUND OF THE INVENTION

### 1. Field of the Invention

The present invention relates to a multi-winding transformer having a plurality of windings, and an insulated power conversion device using the multi-winding transformer.

### 2. Description of the Related Art

With the spread of renewable energy sources in power systems and the development of charging facilities for electric vehicles, medium-to-high voltage insulated AC/DC converters are becoming commonly used as power conversion devices for interconnecting high-voltage AC power supplies and low-voltage DC buses.

As a prior art related to an insulated AC/DC converter, a technology described in WO 2020/217721 A1 has been known.

In the insulated AC/DC converter described in WO 2020/217721 A1 (FIG. 9), a multi-winding transformer including six independent windings is used as a transformer for insulation. An AC output of a DC/AC converter is connected to each of three of the windings. An AC input of an AC/DC converter is connected to each of the other three windings.

The three DC/AC converters convert DC power converted from AC power from an external AC system into AC power having the same voltage phase. The AC power output from the three DC/AC converters is transmitted to the three AC/DC converters via the multi-winding transformer. The three AC/DC converters convert the AC power received via the multi-winding transformer into DC power. An electric vehicle is charged by the DC power output from each of the AC/DC converters.

### SUMMARY OF THE INVENTION

In the prior art described above, insulation between the plurality of windings in the multi-winding transformer is not considered. Further, magnetic coupling through the magnetic core of the multi-winding transformer causes interference between the DC/AC converters, resulting in an unbalanced operation between the plurality of DC/AC converters. For this reason, it is difficult to increase the voltage or capacity of the insulated AC/DC converter.

Therefore, the present invention provides a multi-winding transformer capable of increasing a voltage or a capacity of an insulated power conversion device, and a power conversion device using the multi-winding transformer.

In order to solve the aforementioned problem, a multi-winding transformer for insulation according to the present invention includes a magnetic core having a plurality of legs, and a primary winding and a secondary winding wound around each of the plurality of legs. Voltages having different phases are input from power converters to the primary windings wound around two different ones of the plurality of legs.

In order to solve the aforementioned problem, a power conversion device according to the present invention includes a multi-winding transformer, and the multi-winding transformer includes a magnetic core having a plurality of legs, and a plurality of primary windings and a plurality of secondary windings wound around the plurality of legs. Furthermore, the power conversion device according to the present invention includes a plurality of first power converters that input AC voltages to the plurality of primary windings, and a plurality of second power converters that input AC voltages from the plurality of secondary windings. Two of the first power converters connected to the primary windings wound around two different ones of the plurality of legs output voltages having different phases.

According to the present invention, it is possible to increase a voltage or a capacity of an insulated power conversion device including a multi-winding transformer.

Other problems, configurations, and effects that are not described above will be apparent from the following description of embodiments.

### BRIEF DESCRIPTION OF THE DRAWINGS

FIG. 1 is a schematic configuration diagram illustrating an insulated power conversion device according to a first embodiment;

FIG. 2 is a block diagram illustrating a configuration of a converter unit in FIG. 1;

FIG. 3 is a circuit diagram illustrating an example of an AC/DC converter section in FIG. 2;

FIG. 4 is a circuit diagram illustrating another example of the AC/DC converter section in FIG. 2;

FIG. 5 is a circuit diagram illustrating an example of a DC/AC converter section in FIG. 2;

FIG. 6 is a circuit diagram illustrating another example of the DC/AC converter section in FIG. 2;

FIG. 7 is a block diagram illustrating a configuration of a converter unit in FIG. 1;

FIG. 8 is a circuit diagram illustrating an example of an AC/DC converter section in FIG. 7;

FIG. 9 is a circuit diagram illustrating another example of the AC/DC converter section in FIG. 7;

FIG. 10 is a waveform diagram illustrating a part of a PWM pulse voltage output from the converter unit to a primary winding in FIG. 1;

FIG. 11 is a waveform diagram illustrating an output voltage of the converter unit, an input voltage of the converter unit, and a magnetic flux in each leg in a case where a magnetic core of a multi-winding transformer has three legs;

FIG. 12 is a schematic configuration diagram illustrating an insulated power conversion device according to a second embodiment;

FIG. 13 is a schematic configuration diagram illustrating an insulated power conversion device according to a third embodiment;

FIG. 14 is a schematic configuration diagram illustrating an insulated power conversion device according to a fourth embodiment;

FIG. 15 is a schematic configuration diagram illustrating an insulated power conversion device according to a fifth embodiment; and

FIG. 16 is a schematic configuration diagram illustrating an insulated power conversion device according to a sixth embodiment.

### DESCRIPTION OF THE PREFERRED EMBODIMENTS

Hereinafter, concerning embodiments of the present invention, first to sixth embodiments will be described with reference to the drawings.

In the drawings, the same reference numerals denote the same components or components having similar functions.

### First Embodiment

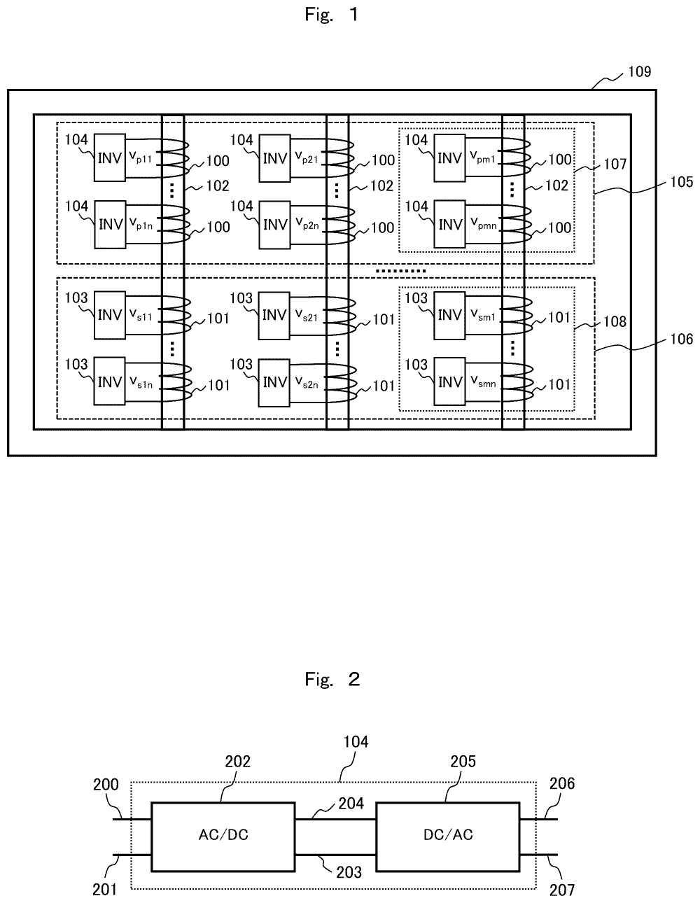

FIG. 1 is a schematic configuration diagram illustrating an insulated power conversion device according to a first embodiment of the present invention.

A multi-winding transformer in the first embodiment has one magnetic core around which a plurality of windings are wound. The magnetic core includes a plurality of legs 102 around which the plurality of windings are wound, and a frame body 109 connecting the plurality of legs 102 to each other. The plurality of legs 102 are arranged in parallel to each other at equal intervals such that their longitudinal directions are parallel to each other. The plurality of legs 102 are magnetically coupled to each other by the frame body 109. That is, the plurality of legs 102 and the frame body 109 constitute one magnetic circuit.

A plurality of primary windings 100 (n primary windings in FIG. 1 (n≥2)) and a plurality of secondary windings 101 (n secondary windings in FIG. 1 (n≥2)) in the same number as the primary windings 100 are wound around each of the plurality of legs 102 (m legs in FIG. 1 (m≥2)). In each of the legs 102, the n primary windings 100 are wound in a split manner so as not to overlap each other while being adjacent to each other on one side in the longitudinal direction of the leg 102. In each of the legs 102, the n secondary windings 101 are wound in a split manner so as not to overlap each other while being adjacent to each other on the other side in the longitudinal direction of the leg 102.

In each of the legs 102, a primary winding set 107 constituted by the n primary windings 100 and a secondary winding set 108 constituted by the n secondary windings 101 are located on one side and the other side, respectively, in the longitudinal direction of the leg 102. That is, in each of the legs 102, the primary winding set 107 and the secondary winding set 108 are wound in a split manner.

A primary winding group 105 constituted by the plurality of primary windings 100 (mn(m×n) primary windings in FIG. 1) in the m legs 102 and a secondary winding group 106 constituted by the plurality of secondary windings 101 (mn(m×n) secondary windings in FIG. 1) in the m legs 102 are located on one sides and the other sides, respectively, in the longitudinal direction of the m legs 102. That is, in the m legs 102, the primary winding group 105 and the secondary winding group 106 are wound in a split manner.

With the configuration of the windings as described above, electrical insulation between the plurality of windings can be improved.

A converter unit 104 is connected to each of the plurality of primary windings 100 (mn(m×n) primary windings in FIG. 1). In the first embodiment, the converter unit 104 includes a DC/AC converter section, that is, an inverter unit. An AC output of the inverter unit is connected to each of the primary windings 100.

A converter unit 103 is connected to each of the plurality of secondary windings 101 (mn(m×n) secondary windings in FIG. 1). In the first embodiment, the converter unit 103 includes an AC/DC converter section. An AC input of the AC/DC converter section is connected to each of the secondary windings 101. In the first embodiment, the inverter unit is operated as an AC/DC converter.

By means of the multi-winding transformer, the plurality of converter units 104 and the plurality of converter units 103 as described above, the power conversion device according to the first embodiment operates as a multi-output insulated AC/DC converter having a plurality of DC outputs.

FIG. 2 is a block diagram illustrating a configuration of the converter unit 104 in FIG. 1.

The converter unit 104 includes an AC/DC converter section 202 and a DC/AC converter section 205. A DC output of the AC/DC converter section 202 and a DC input of the DC/AC converter section 205 are connected to each other by DC buses 203 and 204. The DC buses 203 and 204 is a negative DC bus and a positive DC bus, respectively. The AC input of the AC/DC converter section 202 and the AC input of the DC/AC converter section 205 are an AC input 200 or 201 and an AC output 206 or 207 of the converter unit, respectively.

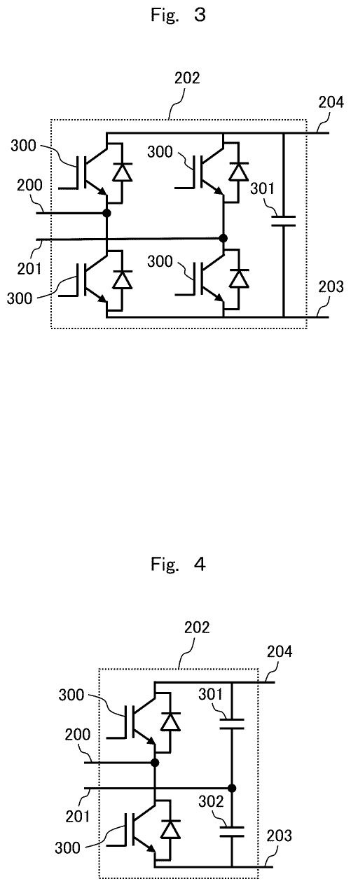

FIG. 3 is a circuit diagram illustrating an example of the AC/DC converter section 202 in FIG. 2.

The AC/DC converter section 202 includes a single-phase full-bridge circuit using a semiconductor device 300 in which a semiconductor switching element (an IGBT in FIG. 3) and a diode are connected to each other in antiparallel, and a DC link capacitor 301 connected in parallel to the single-phase full-bridge circuit. A series connection point between the two semiconductor devices 300 in each half-bridge circuit is referred to as an AC input 200 or 201. A parallel connection point between the two half-bridge circuits and the DC link capacitor 301 is connected to the DC bus 203 or 204 as a DC output.

AC power input to the AC input 200 or 201 is rectified by the diode and converted into DC power. The DC power charges DC link capacitor 301 and is output to the DC buses 203 or 204.

FIG. 4 is a circuit diagram illustrating another example of the AC/DC converter section 202 in FIG. 2.

The AC/DC converter section 202 is formed by connecting, in parallel, a half-bridge circuit using a semiconductor device 300 in which a semiconductor switching element (an IGBT in FIG. 4) and a diode are connected to each other in antiparallel, and a series connection circuit between DC link capacitors 301 and 302. A series connection point between the two semiconductor devices 300 and a series connection point between the two DC link capacitors 301 and 302 in the half-bridge circuit are referred to as AC inputs 200 and 201, respectively. Both ends of the half-bridge circuit, that is, both ends of the series connection circuit between the DC link capacitors 301 and 302, are connected to the DC buses 203 and 204.

AC power input to the AC inputs 200 and 201 is rectified by the diodes and converted into DC power. The DC power alternately charges the DC link capacitors 301 and 302 according to the polarity of the AC input voltage.

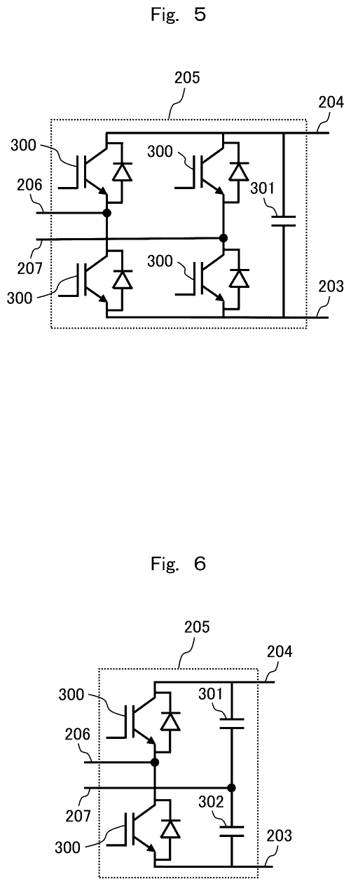

FIG. 5 is a circuit diagram illustrating an example of the DC/AC converter section 205 in FIG. 2.

The DC/AC converter section 205 includes a single-phase full-bridge circuit using a semiconductor device 300 in which a semiconductor switching element (an IGBT in FIG. 5) and a diode are connected to each other in antiparallel, and a DC link capacitor 301 connected in parallel to the single-phase full-bridge circuit. A series connection point between the two semiconductor devices 300 in each half-bridge circuit is referred to as an AC output 206 or 207. A parallel connection point between the two half-bridge circuits and the DC link capacitor 301 is connected to the DC bus 203 or 204 as a DC input.

DC power input from the DC bus 203 or 204 is converted into AC power by a switching operation of the semiconductor device 300. The AC power is output from the AC output 206 or 207.

FIG. 6 is a circuit diagram illustrating another example of the DC/AC converter section 205 in FIG. 2.

The DC/AC converter section 205 is formed by connecting, in parallel, a half-bridge circuit using a semiconductor device 300 in which a semiconductor switching element (an IGBT in FIG. 6) and a diode are connected to each other in antiparallel, and a series connection circuit between DC link capacitors 301 and 302. A series connection point between the two semiconductor devices 300 and a series connection point between the two DC link capacitors 301 and 302 in the half-bridge circuit are referred to as AC outputs 206 and 207, respectively. Both ends of the half-bridge circuit, that is, both ends of the series connection circuit between the DC link capacitors 301 and 302, are connected to the DC buses 203 and 204.

DC power input from the DC bus 203 or 204 is converted into AC power by a switching operation of the semiconductor device 300. The AC power is output from the AC output 206 or 207.

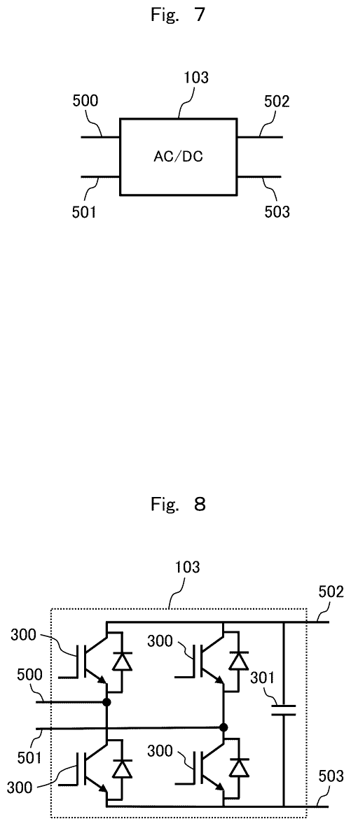

FIG. 7 is a block diagram illustrating a configuration of the converter unit 103 in FIG. 1.

The converter unit 103 includes an AC/DC converter section. A DC output of the AC/DC converter section is connected to the DC buses 502 and 503. The DC buses 502 and 503 are a positive DC bus and a negative DC bus, respectively. An AC input of the AC/DC converter section is an AC input 500 or 501 of the converter unit 103.

FIG. 8 is a circuit diagram illustrating an example of the AC/DC converter section in FIG. 7.

The AC/DC converter section includes a single-phase full-bridge circuit using a semiconductor device 300 in which a semiconductor switching element (an IGBT in FIG. 8) and a diode are connected to each other in antiparallel, and a DC link capacitor 301 connected in parallel to the single-phase full-bridge circuit. A series connection point between the two semiconductor devices 300 in each half-bridge circuit is referred to as an AC input 500 or 501. A parallel connection point between the two half-bridge circuits and the DC link capacitor 301 is connected to the DC bus 502 or 503 as a DC output.

AC power input to the AC input 500 or 501 is rectified by the diode and converted into DC power. The DC power charges DC link capacitor 301 and is output to the DC bus 502 or 503.

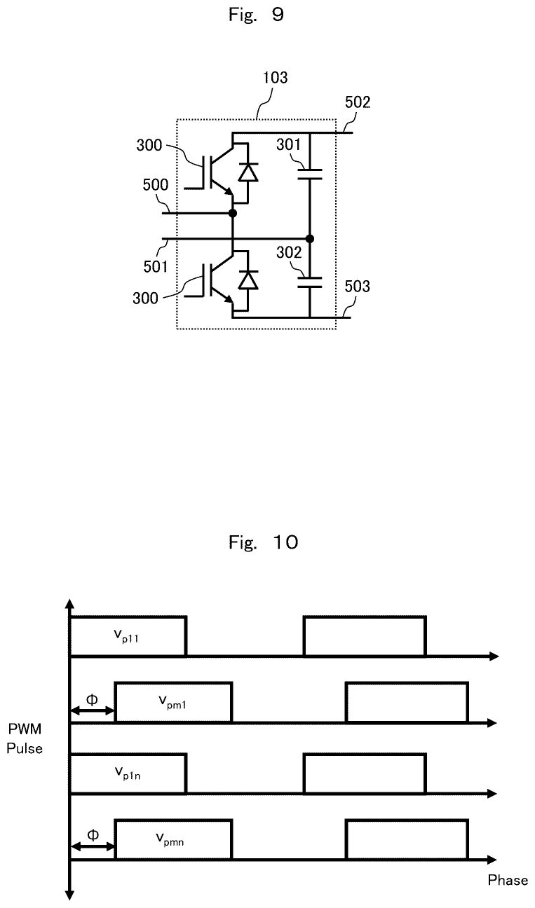

FIG. 9 is a circuit diagram illustrating another example of the AC/DC converter section in FIG. 7.

The AC/DC converter section is formed by connecting, in parallel, a half-bridge circuit using a semiconductor device 300 in which a semiconductor switching element (an IGBT in FIG. 9) and a diode are connected to each other in antiparallel, and a series connection circuit between DC link capacitors 301 and 302. A series connection point between the two semiconductor devices 300 and a series connection point between the two DC link capacitors 301 and 302 in the half-bridge circuit are referred to as AC inputs 500 and 501, respectively. Both ends of the half-bridge circuit, that is, both ends of the series connection circuit between the DC link capacitors 301 and 302, are connected to the DC buses 502 and 503.

AC power input to the AC input 500 or 501 is rectified by the diode and converted into DC power. The DC power alternately charges the DC link capacitors 301 and 302 according to the polarity of the AC input voltage.

FIG. 10 is a waveform diagram illustrating a part of a PWM pulse voltage output from the converter unit 104 to the primary winding 100 in FIG. 1.

The m legs 102 of the magnetic core in the multi-winding transformer are numbered 1, 2, 3, . . . , and m in order from the leftmost leg 102 in a rightward direction in FIG. 1. Output voltages of the n converter units 104 connected to the n primary windings 100 wound around an i-th leg 102 (i=1 to m) are Vₚᵢ₁, Vₚᵢ₂, . . . , and Vₚᵢₙ in order from the uppermost leg 102 in a downward direction in FIG. 1.

As illustrated in FIG. 10, Vₚ₁₁ and Vₚ₁ₙ have the same voltage magnitude, and a phase difference therebetween is zero, that is, they are in phase. Not only Vₚ₁₁ and Vₚ₁ₙ but also Vₚ₁ᵢ (i=1 to m) have the same voltage magnitude, and are in phase. Similarly, output voltages Vpᵢⱼ (j=1 to n) of the n converter units 104 connected to the n primary windings 100 wound around an i-th leg 102 (i=1 to m) have the same voltage magnitude, and are in phase.

As illustrated in FIG. 10, Vₚ₁₁ and Vₚₘ₁ have the same voltage magnitude, and a phase difference therebetween is Φ. Here, Φ=(360°/m)×(m−1). Not only Vₚ₁₁ and Vₚₘ₁ but also Vₚ₁₁ and Vₚᵢ₁ (i=2 to m) have the same voltage magnitude, and a phase difference therebetween is Φ(=(360°/m)×(m−1)). Similarly, output voltages Vₚᵢⱼ (j=1 to n) of the n converter units 104 connected to the n primary windings 100 wound around an i-th leg 102 (i=2 to m) have a phase difference of Φ(=(360°/m)×(i−1)) with respect to Vₚ₁ⱼ (j=1 to n).

When the phase difference is set as described above, output voltages Vₚᵢⱼ and Vₚᵢⱼ₊₁ of converter units 104 connected to primary windings wound around adjacent legs 102 (an i-th leg and an i+1-th leg) have a phase difference of 360°/m. Thus, in the first embodiment, the output voltages of the n converter units 104 connected to the n primary windings 100 wound around each of the legs 102 are in phase. In the first embodiment, output voltages of converter units 104 connected to primary windings wound around any two adjacent legs 102 among the m legs 102 have the same phase difference (=360°/m). In the first embodiment, Vₚᵢⱼ (i=1 to m and j=1 to n) have the same magnitude.

For example, when there are three legs 102, a phase difference between Vₚ₁ⱼ and Vₚ₂ⱼ is 120° (=360°/3), and a phase difference between Vₚ₂ⱼ and Vₚ₃ⱼ is 120° (=360°/3).

The output voltages of converter units 104 connected to primary windings wound around any two adjacent legs 102 among the m legs 102 have the same phase difference (=360°/m). As a result, it is possible to reduce interference between the plurality of converter units 104 connected to the plurality of primary windings wound around the legs 102 caused when the plurality of converter units 104 connected to the plurality of primary windings wound around the plurality of different legs 102 of the multi-winding transformer interfere with each other (for example, cross current). This improves the balance of operation between the plurality of (m×n) converter units 104 connected to the plurality of (m×n) primary windings in the multi-winding transformer.

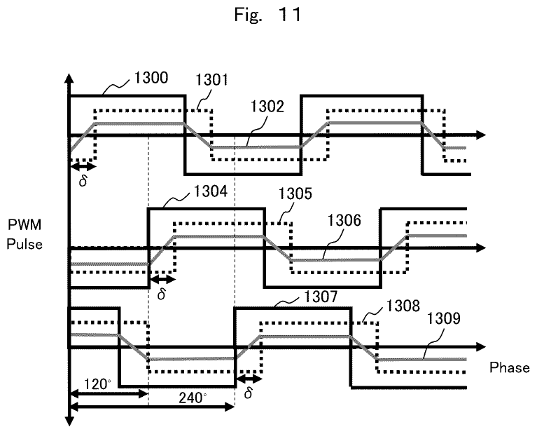

FIG. 11 is a waveform diagram illustrating an output voltage of the converter unit 104 connected to each of the primary windings 100, an input voltage of the converter unit 103 connected to each of the secondary windings 101, and a magnetic flux in each of the legs 102 in a case where the magnetic core of the multi-winding transformer has three legs 102. The horizontal axis represents a phase.

Output voltages 1300, 1304, and 1307 of converter units 104 correspond to Vₚ₁₁ to Vₚ₁ₙ, Vₚ₂₁ to Vₚ₂ₙ, and Vₚ₃₁ to Vₚ₃ₙ illustrated in FIG. 1, respectively.

Input voltages 1301, 1305, and 1308 of the converter units 103 correspond to Vₛ₁₁ to Vₛ₁ₙ, Vₛ₂₁ to Vₛ₂ₙ, and Vₛ₃₁ to Vₛ₃ₙ illustrated in FIG. 1, respectively.

Similarly to the output voltages of the converter units 104 In FIG. 1, the output voltages of the n converter units 103 connected to the n secondary windings 101 wound around an i-th leg 102 (i=1 to m) are Vₛᵢ₁, Vₛᵢ₂, . . . , and Vₛᵢₙ in order toward the lowermost leg 102 in FIG. 1.

Magnetic fluxes 1302, 1306, and 1309 correspond to magnetic fluxes in the first, second, and third legs 102, respectively.

As illustrated in FIG. 11, a phase difference between the output voltages 1300 and 1304 is 120°. A phase difference between the output voltages 1300 and 1307 is 240 degrees, and thus, a phase difference between the output voltages 1304 and 1307 is 120 degrees. A phase difference between the output voltages 1307 and 1300 of the converter units 104 is also 120°. As a result, the operations of the plurality of converter units 104 are balanced, and accordingly, the magnitudes (amplitudes) of the magnetic fluxes 1302, 1306, and 1309 become uniform.

As illustrated in FIG. 11, the input voltage 1301 is delayed in phase by δ with respect to the output voltage 1300. Similarly, the input voltage 1305 is delayed in phase by δ with respect to the output voltage 1304, and the input voltage 1308 is delayed in phase by δ with respect to the output voltage 1307. Here, in the corresponding converter unit 103, the switching of the semiconductor switching element is controlled by a control device (not illustrated) so that the input voltage is delayed in phase by δ with respect to the output voltage.

Depending on the phase delay δ, power is transmitted from the converter unit 104 via the multi-winding transformer to the converter unit 103.

As described above, according to the first embodiment, the multi-winding transformer includes the plurality of legs 102 around which the primary winding 100 and the secondary winding 101 are wound in a split manner, and voltages having different phases are input from the converter units 104 to the primary windings wound around the different legs. As a result, the balance between the magnitudes of the magnetic fluxes in the plurality of legs is improved, and the balance between the operations of the plurality of converter units 104 is improved.

Therefore, the power loss of the insulated power conversion device can be reduced, and the capacity of the insulated power conversion device can be increased.

At least one primary winding and at least one secondary winding may be provided around each of the legs 102.

Further, according to the first embodiment, windings 100 and 101 or 800 and 801 are wound around each of the legs 102 in a split manner. This improves electrical insulation between the windings. Therefore, it is possible to increase the voltage or the capacity of the insulated power conversion device including the multi-winding transformer.

In addition, according to the first embodiment, the power capacity and the number of outputs of the insulated multi-output power conversion device can be easily set depending on the number of legs 102 including windings with the same configuration.

In this manner, according to the first embodiment, it is possible to increase the voltage or the capacity of the insulated power conversion device.

### Second Embodiment

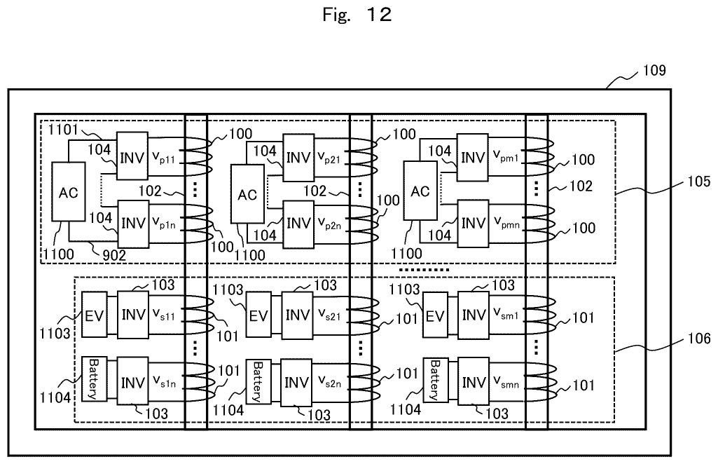

FIG. 12 is a schematic configuration diagram illustrating an insulated power conversion device according to a second embodiment of the present invention.

Hereinafter, differences from the first embodiment will be described.

As illustrated in FIG. 12, AC inputs of a plurality of converter units 104 (n converter units (n≥2) in FIG. 12) of which AC outputs are connected to a plurality of primary windings 100 (n primary windings (n≥2) in FIG. 12) wound around each of the legs 102 are connected to each other in series. A single-phase AC power supply 1100 is connected to both ends of the series connection between the AC inputs, that is, connection terminals 1101 and 902. As a result, the power supply voltage of the single-phase AC power supply 1100 can be increased.

As illustrated in FIG. 12, DC outputs of a plurality of converter units 103 (n converter units (n≥2) in FIG. 12) of which AC inputs are connected to a plurality of secondary windings 101 (n secondary windings (n≥2) in FIG. 12) wound around each of the legs 102 are connected to either electric vehicles 1103 or batteries 1104.

In this manner, in the insulated power conversion device according to the second embodiment, a plurality of batteries 1104, a plurality of electric vehicles 1103, or the batteries 1104 and the electric vehicles 1103 can be charged simultaneously.

### Third Embodiment

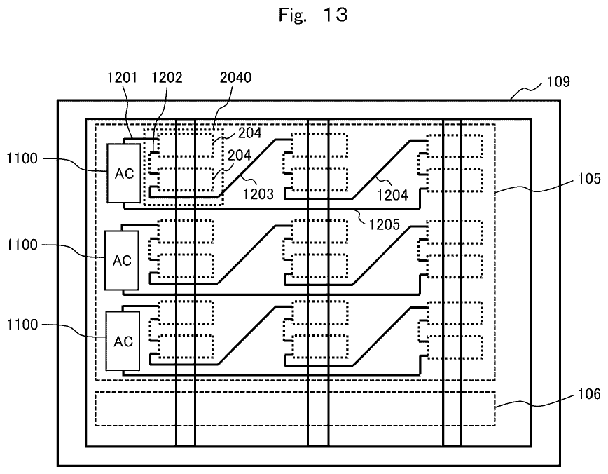

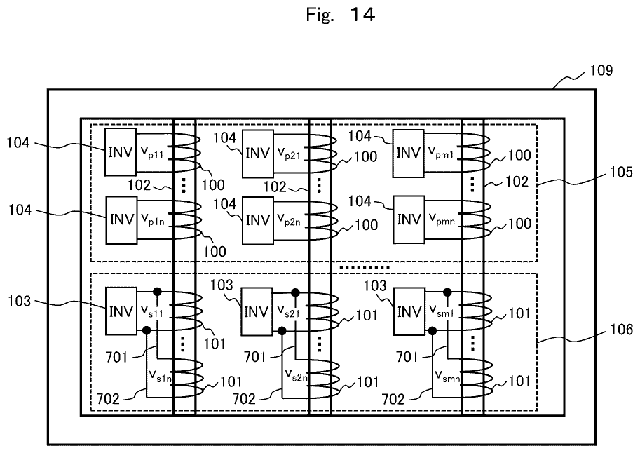

FIG. 13 is a schematic configuration diagram illustrating an insulated power conversion device according to a third embodiment of the present invention.

Hereinafter, differences from the first embodiment will be described.

In each of the plurality of legs 102 (three legs in FIG. 13), a plurality of primary windings (six primary windings in FIG. 13) are classified into a plurality of primary winding sets 2040 (three primary winding sets in FIG. 13) each including a plurality of primary windings (two primary windings in FIG. 13).

Here, the three primary winding sets 2040 are referred to as a first primary winding set, a second primary winding set, and a third primary winding set from the uppermost primary winding set in FIG. 13.

AC inputs of two converter units 204 (corresponding to the converter units 104) connected to the first primary winding set are connected to each other in series by a connecting conductor 1202. The AC inputs of the converter units 204 in the three legs 102 are connected to each other in series by connecting conductors 1203 and 1204. That is, the AC inputs of the six converter units 204 connected to the three first primary winding sets wound around the three legs 102 are connected to each other in series. A single-phase AC power supply 1100 is connected to both ends of the series connection between the AC inputs of the six converter units 204, that is, connection terminals 1201 and 1205.

In the second primary winding set and the third primary winding set as well, both ends of the series connection between the AC inputs of the six converter units are connected to a single-phase AC power supply.

According to the third embodiment, the power supply voltage of the single-phase AC power supply 1100 can be increased.

### Fourth Embodiment

FIG. 14 is a schematic configuration diagram illustrating an insulated power conversion device according to a fourth embodiment of the present invention.

Hereinafter, differences from the first embodiment will be described.

As illustrated in FIG. 14, connection terminals 701 and 702 of a plurality of secondary windings 101 wound around each of the legs 102 are connected to AC inputs of one converter unit 103.

According to the fourth embodiment, it is possible to reduce the number of converter units 103 while maintaining the total power capacity of the insulated power conversion device.

### Fifth Embodiment

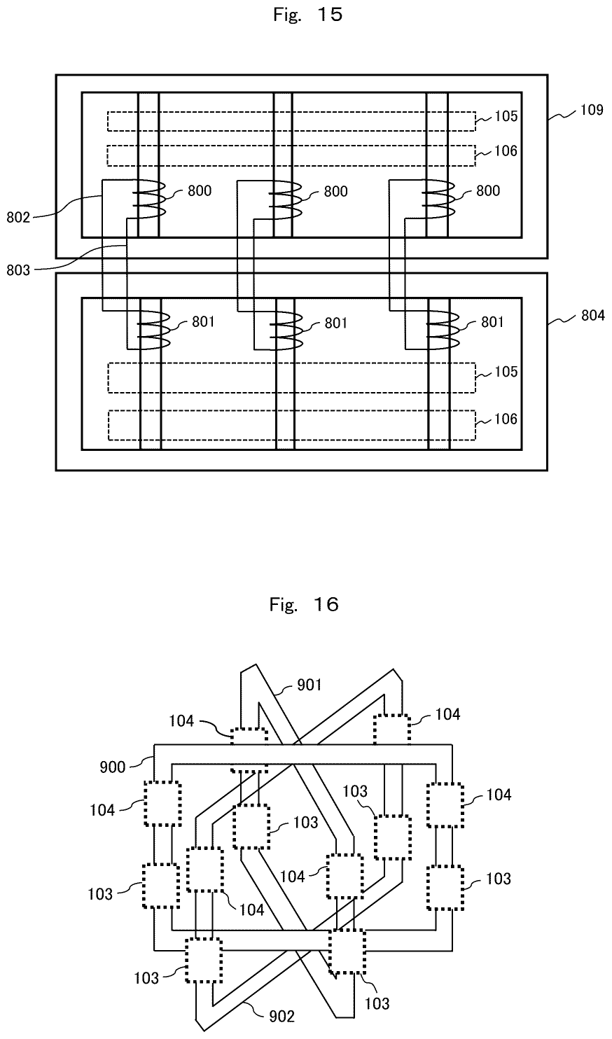

FIG. 15 is a schematic configuration diagram illustrating an insulated power conversion device according to a fifth embodiment of the present invention.

Hereinafter, differences from the first embodiment will be described.

The insulated power conversion device according to the fifth embodiment includes a first insulated AC/DC converter in which a magnetic core of a multi-winding transformer has a frame body 109, and a second insulated AC/DC converter in which a magnetic core of a multi-winding transformer has a frame body 804. Both the first insulated AC/DC converter and the second insulated AC/DC converter have the same configuration as the insulated AC/DC converter according to the first embodiment (FIG. 1).

A tertiary winding 800 is wound around each of the legs of the magnetic core of the multi-winding transformer of the first insulated AC/DC converter. A tertiary winding 801 is wound around each of the legs of the magnetic core of the multi-winding transformer of the second insulated AC/DC converter in a split manner.

The tertiary winding 800 wound around an i-th leg of the magnetic core of the multi-winding transformer of the first insulated AC/DC converter and the tertiary winding 801 wound around an i-th leg of the magnetic core of the multi-winding transformer of the second insulated AC/DC converter are connected to each other by connecting conductors 802 and 803 to form a loop circuit.

When an imbalance occurs between a magnetic flux at the i-th leg of the magnetic core of the multi-winding transformer of the first insulated AC/DC converter and a magnetic flux at the i-th leg of the magnetic core of the multi-winding transformer of the second insulated AC/DC converter, the imbalance is suppressed by a magnetic flux generated by an induced current flowing through the loop circuit constituted by the tertiary windings 800 and 801. As a result, the operations of the plurality of converter units 104 are balanced.

### Sixth Embodiment

FIG. 16 is a schematic configuration diagram illustrating an insulated power conversion device according to a sixth embodiment of the present invention.

Hereinafter, differences from the first embodiment will be described.

A multi-winding transformer in the sixth embodiment includes a plurality of magnetic cores (three magnetic cores in FIG. 16) each including two legs. The two legs are connected to each other by a connector. As a result, the magnetic core has a rectangular frame shape. A primary winding and a secondary winding are wound around each of the legs in a split manner as in the first embodiment. As in the first embodiment, converter units 104 and 103 are connected to the primary winding and the secondary winding, respectively.

The three magnetic cores 900, 901, and 902 are magnetically coupled to each other in such a manner that the connectors form the same angle with each other. As a result, the multi-winding transformer including six legs is formed.

According to the sixth embodiment, by three-dimensionally forming the multi-winding transformer, it is possible to reduce the installation area of the multi-winding transformer.

It should be noted that the present invention is not limited to the above-described embodiments, and includes various modifications. For example, the above-described embodiments have been described in detail in order to explain the present invention in an easy-to-understand manner, and are not necessarily limited to those having all the configurations described above. In addition, other configurations may be added to some of the configurations of each embodiment, some of the configurations of each embodiment may be deleted, or some of the configurations of each embodiment may be replaced with other configurations.

For example, the semiconductor switching elements used in the converter units 103 and 104 are not limited to the IGBTs, and may be MOSFETs, junction bipolar transistors, or the like.

What is claimed is:

1. A multi-winding transformer for insulation, comprising:
a magnetic core having a plurality of legs; and
a primary winding and a secondary winding wound around each of the plurality of legs, wherein
voltages having different phases are input from power converters to the primary windings wound around two different legs among the plurality of legs.

2. The multi-winding transformer according to claim 1, wherein
in the magnetic core, the plurality of legs are magnetically coupled to each other while being arranged in parallel to each other, and
a phase difference between the voltage input to the primary winding wound around one of the plurality of legs and the voltage input to the primary winding wound around another leg adjacent to the one leg is 360°/m when the number of the plurality of legs is m.

3. The multi-winding transformer according to claim 1, wherein the primary winding and the secondary winding are wound in a split manner.

4. The multi-winding transformer according to claim 3, wherein
a plurality of primary windings and a plurality of secondary windings are provided, and
the plurality of primary windings are wound in a split manner, and the plurality of secondary windings are wound in a split manner.

5. The multi-winding transformer according to claim 4, wherein the plurality of secondary windings are connected to each other in parallel.

6. A power conversion device comprising:
a multi-winding transformer for insulation including a magnetic core having a plurality of legs, and a plurality of primary windings and a plurality of secondary windings wound around the plurality of legs;
a plurality of first power converters configured to input AC voltages to the plurality of primary windings; and
a plurality of second power converters configured to input AC voltages from the plurality of secondary windings, wherein
two of the first power converters connected to the primary windings wound around two different ones of the plurality of legs output voltages having different phases.

7. The power conversion device according to claim 6, wherein
in the magnetic core, the plurality of legs are magnetically coupled to each other while being arranged in parallel to each other, and
a phase difference between the AC voltage input by the first power converter to the primary winding wound around one of the plurality of legs and the AC voltage input by the first power converter to the primary winding wound around another leg adjacent to the one leg is 360°/m when the number of the plurality of legs is m.

8. The power conversion device according to claim 6, wherein the plurality of primary windings and the plurality of secondary windings are wound in a split manner.

9. The power conversion device according to claim 6, wherein
a plurality of AC inputs of the plurality of first power converters are connected to each other in series, and
the plurality of AC inputs connected to each other in series are connected to an AC power supply.

10. The power conversion device according to claim 6, wherein
a plurality of primary windings and a plurality of secondary windings are wound around each of the plurality of legs, and
the plurality of primary windings are wound in a split manner, and the plurality of secondary windings are wound in a split manner.

11. The power conversion device according to claim 10, wherein the plurality of secondary windings are connected to each other in parallel.

12. A power conversion device comprising:
a first multi-winding transformer and a second multi-winding transformer for insulation, each including a magnetic core having a plurality of legs, and a plurality of primary windings and a plurality of secondary windings wound around the plurality of legs;
a plurality of first power converters configured to input AC voltages to the plurality of primary windings; and
a plurality of second power converters configured to input AC voltages from the plurality of secondary windings, wherein
two of the first power converters connected to the primary windings wound around two different ones of the plurality of legs output voltages having different phases, and
a tertiary winding wound around each of the plurality of legs of the magnetic core included in the first multi-winding transformer and a tertiary winding wound around each of the plurality of legs of the magnetic core included in the second multi-winding transformer form a loop circuit.
